(19) United States
(12) Patent Application Publication
(10) Pub. No.: US 2006/0147772 A1
(43) Pub. Date: Jul. 6, 2006

(54) Fuel cell system

(75) Inventor: Shinichiro Takemoto, Yokohama-shi (JP)

Correspondence Address: SHUMAKER & SIEFFERT, P. A., 8425 SEASONS PARKWAY, SUITE 105, ST. PAUL, MN, 55125, US

(73) Assignee: Nissan Motor Co., Ltd., Yokohama-shi (JP)

(21) Appl. No.: 11/313,237

(22) Filed: Dec. 20, 2005

(30) Foreign Application Priority Data
Dec. 20, 2004 (JP) 2004-368328

(51) Int. Cl. H01M 8/04

(52) U.S. Cl. 429/24; 429/26; 429/34; 429/13

(57) ABSTRACT

A fuel cell system includes a bypass circuit for refrigerant that is used when the system is started below a temperature point, such as the freezing point of water. In one embodiment, the fuel cell system includes a pump to circulate the refrigerant and one or more valves to direct the refrigerant to bypass a fuel cell stack when the refrigerant is below the temperature point. The refrigerant may also be directed through a second bypass away from reaching a radiator during startup. In this manner, the fuel cell stack may generate electricity and heat itself during these processes without the possibility of the refrigerant freezing the water produced from the electricity generation.

This application claims priority from Japanese Patent Application No. 2004-368328, filed Dec. 20, 2004, the entire contents of which are incorporated herein by reference.

### TECHNICAL FIELD

The invention relates to fuel cell systems, more particularly, to regulating fuel cell system temperatures.

### BACKGROUND

Fuel cells take out electric energy directly from electrodes placed on the both sides of electrolyte by electrochemical reaction of fuel gas (such as hydrogen gas) with oxidizing gas (which contains oxygen) through electrolyte between them. In particular, polymer electrolyte fuel cells, which use solid polymer electrolyte, are the center of attention as power source of electric vehicles because of the low operation temperature and easy handling. In other words, fuel cell vehicles load hydrogen storage equipment such as high pressure hydrogen tanks, liquid hydrogen tanks or hydrogen-absorbing alloy tanks. Hydrogen supplied by the equipment and air which contains oxygen are introduced into a fuel cell to react. Hydrogen reacts with oxygen to create electric energy which is taken out of the fuel cell to drive a motor which is connected to driving wheels. It is ultimately a clean vehicle since only water is discharged as emissions.

When this type of fuel cell system is started up in a below-freezing point environment, cold cooling water is introduced into the fuel cell stack which is not warmed up yet, water formed by electricity generating reaction freezes within the fuel cell stack, causing occlusion of reaction gas passages or blockage of hydrogen ion transmission in the solid polymer film, which disables continuation of electricity generation.

Conventionally, the cooling water is warmed up by a heat reservoir before introducing the water into the fuel cell stack. In this manner, the inside of the fuel cell stack is warmed to enable electricity generation. When the temperature in the fuel cell rises above the predetermined temperature, the cooling water is switched to be cooled by a heat exchanger to cool and control the temperature of the fuel cell.

However, heating the cooling water within a reservoir may require a heat reservoir with a large heat capacity, which increases the weight and size of the vehicle. In addition, a heater with larger heat capacity and power source is required since temperature of the cooling water increases slowly.

### SUMMARY

In general, the disclosure is directed to a fuel cell system that includes a bypass circuit for refrigerant. When the fuel cell system is started in a low temperature condition, such as below freezing point, the fuel cell stack generates electricity while the refrigerant bypasses the fuel cell stack. In this manner, cold cooling water is prevented from being introduced into the fuel cell stack, which allows the fuel stack temperature to increase more quickly in response to the electricity generation.

In addition, a heating unit may be used to heat the refrigerant within the bypass. As a result, it takes a relatively shorter time to increase temperature using a heating unit with only small heat capacity because the heat capacity of the refrigerant in the bypass passage is smaller than the heat capacity of the refrigerant in the fuel cell stack and

When antifreeze (such as ethylene glycol solution) is used as the refrigerant, pump load may be decreased due to higher resistance of the refrigerant because the refrigerant has high viscosity at low temperature. In the described fuel cell system, temperature of the refrigerant increases quicker because it needs to heat up in the bypass passage only, this enables the system to reach a maximum load of the pump in shorter time. Additionally, the pump load can be maximized when receiving electric power from the fuel cell stack, as well as to accelerate a temperature increase of the fuel cell stack. It may be possible to enable continuous electricity generation without freezing the water formed in the fuel cell stack.

The fuel cell system may alternatively include a temperature detecting switch valve to eliminate the need for a separate temperature sensor, which may effectively lower the cost and decrease the mass of the fuel cell system.

In one embodiment, the disclosure is directed to a fuel cell system including a fuel cell stack, a main circulation passage where a refrigerant flow through the fuel cell stack, a bypass passage where the refrigerant bypasses the fuel cell stack, a valve that switches the refrigerant between the main circulation passage and the bypass passage, a heating unit that heats the refrigerant a sensor that detects a temperature of the refrigerant, and a controller that controls the valve to direct the refrigerant flow through the bypass passage, wherein the controller engages the heating unit to heat the refrigerant that bypasses the fuel cell when the temperature of the refrigerant is below a first predetermined value, and when starting the fuel cell system.

In another embodiment, the disclosure is directed to a fuel cell system including a fuel cell stack, a main circulation passage where a refrigerant flows through the fuel cell stack, a pump that creates a circulation of the refrigerant, a bypass passage where the refrigerant bypasses the fuel cell stack, a valve which automatically switches a flow of the refrigerant between the bypass passage and the main circulation passage, wherein the valve directs the refrigerant through the bypass passage when the temperature of the refrigerant is below a first predetermined value, and wherein the valve directs the refrigerant through the main circulation passage when the temperature of the refrigerant is above a second predetermined value greater than the first predetermined value, a heating unit that heats the refrigerant, a sensor that detects a temperature of the refrigerant, and a controller that engages the heating unit to heat the refrigerant and drives the pump when the temperature of the refrigerant is below a first predetermined value and when starting the fuel cell system.

In an alternative embodiment, the disclosure is directed to a method for starting a fuel cell system including detecting a temperature of a refrigerant in a fuel cell stack when the temperature of the refrigerant is below a first predetermined value; directing the refrigerant from a main circulation passage through the fuel cell stack to a bypass passage to bypass the refrigerant away from the fuel cell stack, and heating the refrigerant that bypasses the fuel cell stack, wherein heating the refrigerant comprises heating the refrigerant with a heater located within the bypass passage.

In another alternative embodiment, the disclosure is directed to a fuel cell system including means for detecting a temperature of a refrigerant in a fuel cell stack, means for bypassing the refrigerant away from the fuel cell stack, means for directing the refrigerant from a passage through the fuel cell stack to a bypassing means to bypass the refrigerant away from the fuel cell stack when the temperature of the refrigerant is below a first predetermined value, and means for heating the refrigerant that bypasses the fuel cell stack.

In some embodiments, refrigerant is introduced at a burst into the fuel cell stack once the temperature rises to a second predetermined value to start generating electricity. In this manner, it may be possible to shorten the time for the fuel cell stack to reach a certain temperature at which it can continue electricity generation due to an increase of temperature of the heating unit and the fuel cell stack. This may occur even after the refrigerant temperature drops at the outlet of the stack, depending on the size of the heat capacity of the fuel cell stack. This process may make it possible to enable electricity generation from temperatures below freezing point even without preheating the fuel cell stack.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a schematic diagram illustrating an exemplary embodiment of a fuel cell system.

FIG. 2 is a schematic diagram illustrating a second exemplary embodiment of a fuel cell system that includes an additional temperature sensor.

FIG. 3 is a graph of exemplary temperature and generated electric power with respect to time in a fuel cell system containing no heating units.

FIG.4 is a graph of temperature and generated electric power with respect to time when the fuel cell system incorporates heating units for the refrigerant.

FIG. 5 is a graph of temperature and generated electric power with respect to time in a fuel cell system which operates a pump by generated electric power from the fuel cell.

FIG. 6 is a graph of temperature and generated electric power with respect to time in a fuel cell system which operates a pump by generated electric power from a secondary power source.

FIG. 7 is a flowchart illustrating an exemplary embodiment of a fuel cell system bypassing the fuel cell stack until a predetermined temperature is reached.

FIG. 8 is a flowchart illustrating an exemplary embodiment of a fuel cell system bypassing the fuel cell stack until a predetermined time is reached.

FIG. 9 is a flowchart illustrating a second exemplary embodiment of a fuel cell system where the pump is run at a maximum load to heat the refrigerant.

FIG. 10 is a flowchart illustrating a second exemplary embodiment of a fuel cell system for heating refrigerant before generating electricity.

FIG. 11 is a flowchart illustrating a second exemplary embodiment of an alternative fuel cell system for heating refrigerant before generating electricity.

### DETAILED DESCRIPTION

In the following, carrying out modes of this invention is explained in detail when referring to each of the drawings. Each of the examples explained below is related to fuel cell systems used outdoors where temperatures can be below a freezing point of water, or 0 degrees Celsius, such as fuel cell systems for fuel cell vehicles.

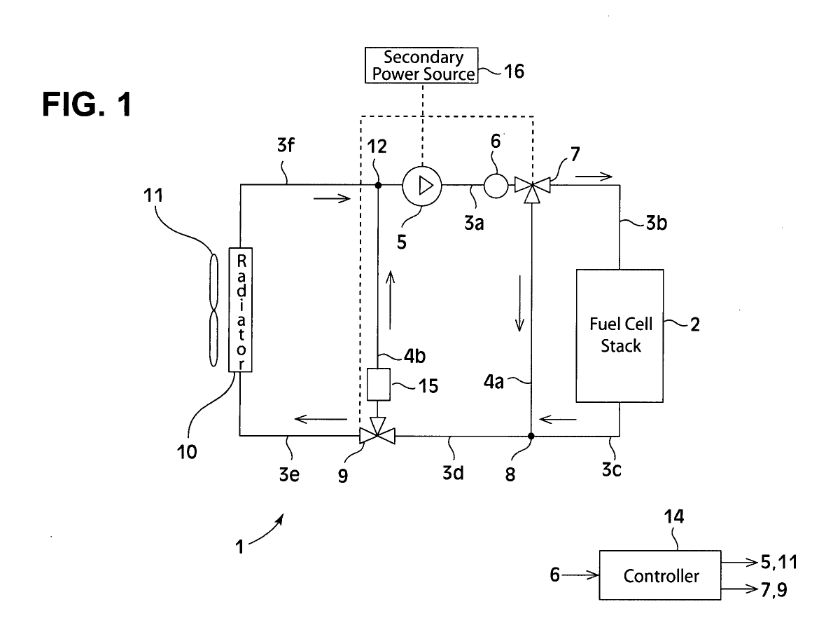

FIG. 1 is a schematic diagram illustrating an exemplary fuel cell system 1. In the example of FIG. 1, fuel cell system 1 includes a fuel cell stack 2 (such as polymer electrolyte type), a main circulation passages 3a-3f in which refrigerant (such as ethylene glycol) circulates, and a bypass passage 4b which bypasses radiator 10. Fuel cell system 1 also includes a pump 5 which creates circulation of refrigerant and thermosensor 6 which detects refrigerant temperature. System 1 additionally includes three-way valve 7 which switches between the passage 3b which passes through the fuel cell stack 2 and the bypass passage 4b, three-way valve 9 which switches between the passage 3e which passes through radiator 10 and the bypass passage 4b, radiator 10 which discharges refrigerant heat out of the system, and radiator fan 11 which blows air to radiator 10.

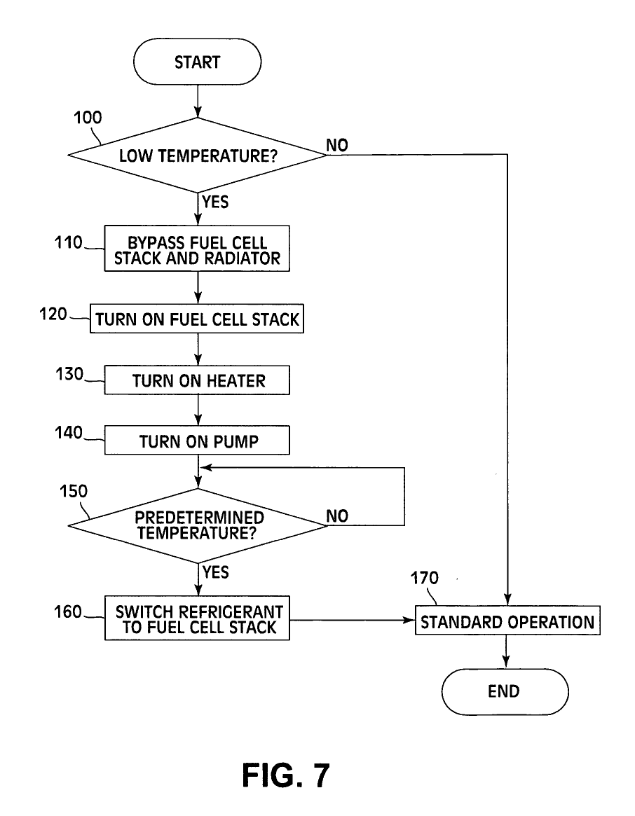

During standard operation (as shown in FIGS. 7-11 as 170, 270, 380, 480, 590), refrigerant circulates through pump 5, three-way valve 7, fuel cell stack 2, concourse 8, three-way valve 9, radiator 10, concourse 12, returning to pump 5. By this passage, heat generated by fuel cell stack 2 is discharged out of the system from radiator 10, keeping refrigerant temperature to the appropriate level suited for fuel cell stack 2 operation.

FIG. 7 is a flowchart illustrating an exemplary embodiment of a fuel cell system. If fuel cell system 1 is started in low temperature (100), such as below freezing point, three-way valve 7 is switched to the bypass passage 4a and three-way valve 9 is switched to the bypass passage 4b so that fuel cell stack 2 and radiator 10 is bypassed (110).

By switching the three-way valves, refrigerant circulates through pump 5, three-way valve 7, bypass passage 4a, concourse 8, three-way valve 9, bypass passage 4b, concourse 12, returning to the pump 5. A heater 15, which is a heating unit, may be placed to be able to heat one of the four passages: main circulation passage 3a, bypass passage 4a, main circulation passage 3d or bypass passage 4b. Heater 15 includes a heat capacity that defines its ability to heat the refrigerant.

The fuel cell stack 2 starts producing electricity (120) and supplies power to pump 5 and heater 15. While heating the refrigerant with heater 15 (130), pump 5 circulates the refrigerant (140). When thermosensor 6 detects that the temperature of the fuel cell stack 2 reaches to the predetermined temperature (e.g. 80 degrees Celsius) at which the fuel cell stack 2 can generate electricity effectively (150), controller 14 switches three-way valve 7 from bypass passage 4a side to fuel cell stack 2 side to introduce the refrigerant at the predetermined temperature into the fuel cell stack 2 at a burst (160).

In case that electric generation of fuel cell stack 2 is not stable right after starting-up, there may not be enough electric current to start up pump 5. In that case, a secondary power source 16 supplies power to the pump 5 for such an unstable period. The secondary power source 16 may only need to have a small capacity for electric generation since power may only be required until electricity generation from fuel cell stack 2 becomes stable. Although 80 Celsius is described as one example temperature at which the three-way valves is switched, it is also possible to switch the three-way valves at 80 degrees Celsius plus an additional adjustment which is calculated from the actual temperature detected before heating at the bypass passage 4a and the possible temperature drop in the passage 3b from three-way valve 7 to fuel cell stack 2.

In the example of FIG. 1, an electronically controlled valve is used as three-way valve 7. If a temperature detecting three-way valve is used instead, the valve starts operation at the temperature the stack can generate electricity effectively by adjusting the switching temperature. The valve may automatically open as soon as temperature of the refrigerant reaches the predetermined level, which causes introduction of the refrigerant into the stack, without use of the thermosensor.

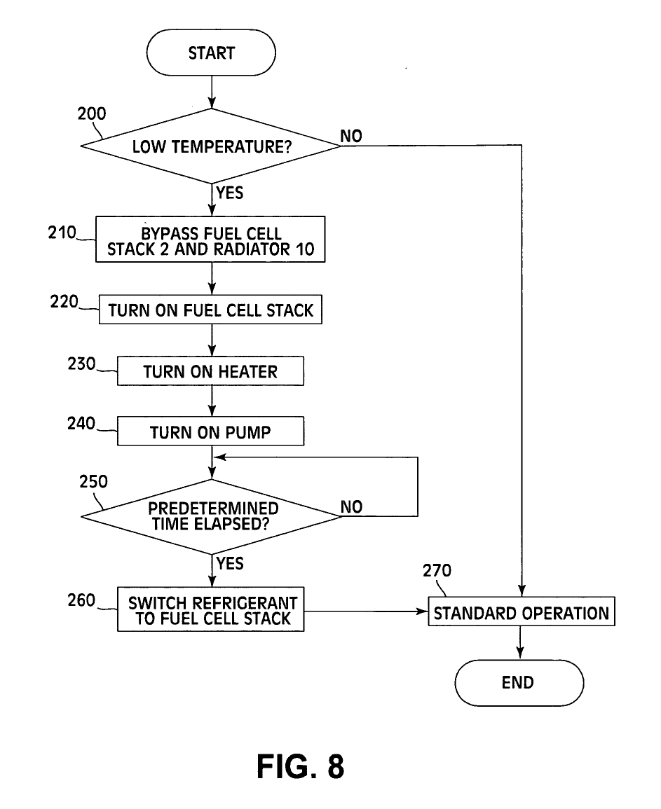

It is also possible to estimate a temperature rise rate of the refrigerant related to outside temperature and heater 15 capacity. FIG. 8 is a flowchart illustrating an exemplary embodiment of a fuel cell system. This may be done by using an outside air temperature sensor to detect outside air temperature, instructing controller 14 to calculate a time required to increase the temperature of the refrigerant from outside air temperature to the predetermined temperature with the heater 15 at the starting-up of fuel cell stack 2 (200). The refrigerant is circulated to bypass the fuel cell stack 2 and the radiator 10 (210, 220, 230, 240), switching three-way valve 7 to flow refrigerant to the fuel cell stack 2 when the estimated time elapses (250), and introducing the heated refrigerant into the fuel cell stack 2 (260).

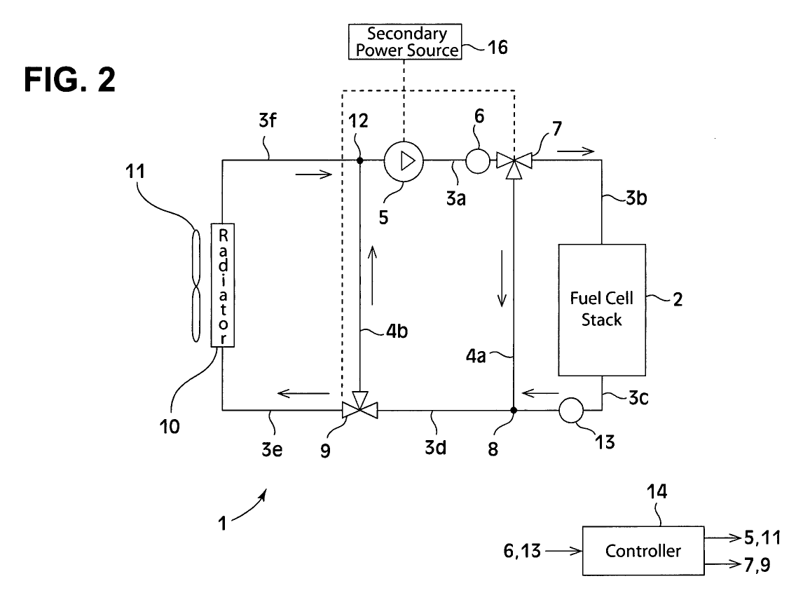

FIG. 2 is a schematic diagram illustrating a second exemplary embodiment of the fuel cell system 1 with an additional temperature sensor 13. FIG. 2 is substantially similar to FIG. 1, with the addition of thermosensor 13 (second thermosensor) which detects the temperature of the refrigerant near the outlet of fuel cell stack 2. Also, pump 5 is driven by an actuator, and the refrigerant flows near the actuator. Therefore, pump 5 is cooled with the refrigerant discharged by the pump itself so that the refrigerant can be heated by operating pump 5 with high load. Since other structure is the same as the example of FIG. 1, the same labels are given to the same structural elements to eliminate duplicate explanation.

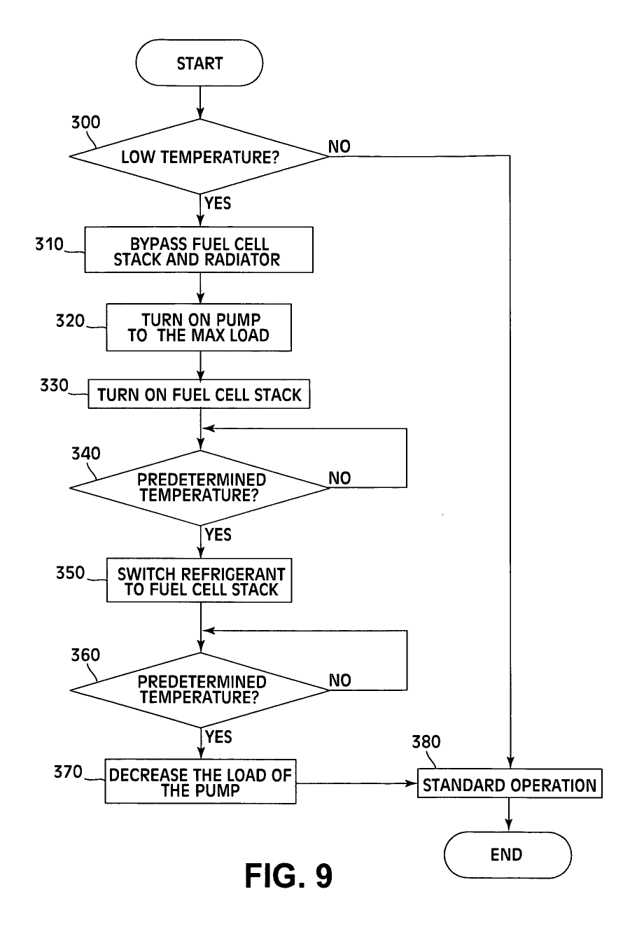

FIG. 9 is a flowchart illustrating a second exemplary embodiment of a fuel cell system. If fuel cell system 1 is started-up in low temperature (300), such as below freezing point, three-way valve 7 is switched to flow refrigerant through bypass passage 4a and three-way valve 9 is switched to bypass passage 4b so that fuel cell stack 2 and radiator 10 is bypassed (310). By switching the three-way valves, refrigerant circulates through pump 5, three-way valve 7, bypass passage 4a, concourse 8, three-way valve 9, bypass passage 4b, concourse 12, returning to the pump 5.

Next, pump 5 is operated with high load or maximum load to heat up the refrigerant in the above-mentioned passages (320). At the same time, fuel cell stack 2 starts generating electricity (330). If the temperature reaches the predetermined value (340), three-way valve 7 is switched to introduce refrigerant into fuel cell stack 2 (350). After confirming the temperature of entire fuel cell stack 2 reaches the predetermined temperature with thermosensor 13 at the outlet of the stack (360), the load of pump 5 is decreased (370), and cycle frequency of pump 5, cycle frequency of radiator fan 11 and opening of three-way valves 7 and 9 are controlled so that temperature becomes within appropriate range (380).

In the following, other elements of the exemplary embodiment will be explained. These elements include controls that operate pumps and other devices powered by the secondary power source to increase temperature of the refrigerant to the predetermined level, switching the three-way valves to the fuel cell stack side, and starting electricity generation by the fuel cell stack.

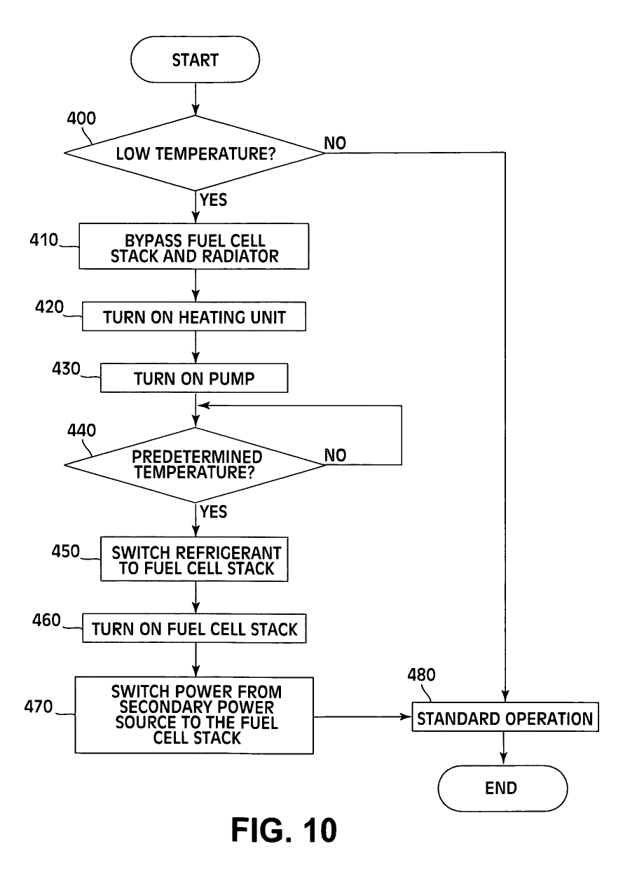

FIG. 10 is a flowchart illustrating a second exemplary embodiment of a fuel cell system for heating refrigerant before generating electricity. When fuel cell system 1 is started-up in low temperature (400), such as below freezing point, three-way valve 7 is switched to the bypass passage 4a and three-way valve 9 is switched to the bypass passage 4b so that fuel cell stack 2 and radiator 10 is bypassed (410). While heating the refrigerant by a heat source such as a heating unit (420), pump 5 is operated by secondary power source 16 (external power source), or means for heating the refrigerant, to circulate the refrigerant (430). By monitoring temperature of the refrigerant with thermosensor 6, as soon as confirming that it reaches to the temperature the stack can generate electricity effectively (440), three-way valve 7 is switched from bypass passage 4a side to fuel cell stack 2 side to introduce the refrigerant at the predetermined temperature into the fuel cell stack 2 at a burst (450). At the same timing as the three-way valve 7 switching, fuel cell stack 2 starts electricity generation (460), and operating power source of pump 5 and three-way valve 7 is switched from the secondary power source 16 to the one generated by fuel cell stack 2 (470). Standard operation of fuel cell system 1 subsequently begins (480).

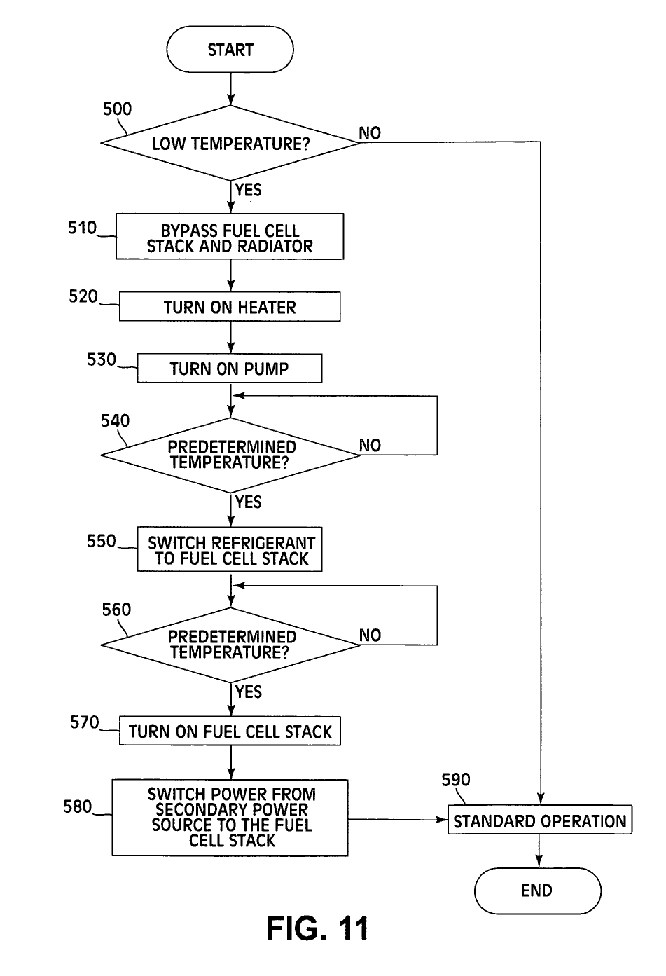

FIG. 11 is a flowchart illustrating a second exemplary embodiment of an alternative fuel cell system that heats refrigerant before beginning electricity generation. Fuel cell system 1 begins by directing refrigerant to bypass fuel cell stack 2, similar to FIG. 10 (500, 510, 520, 530). As soon as thermosensor 6 detects that fuel cell stack 2 reaches the temperature the stack can generate electricity effectively (540), three-way valve 7 is switched from bypass passage 4a side to fuel cell stack 2 side to introduce the refrigerant at the predetermined temperature into the fuel cell stack 2 at a burst (550). Next, when thermosensor 13 detects that the refrigerant temperature at the outlet of fuel cell stack 2 reaches to the predetermined temperature (560), fuel cell stack 2 starts generating electricity (570) and operating as a power source for pump 5, and three-way valves 7 and 9 are switched from secondary power source 16 to fuel cell stack 2 (580). Standard operation follows once the refrigerant is above the predetermined temperature (590).

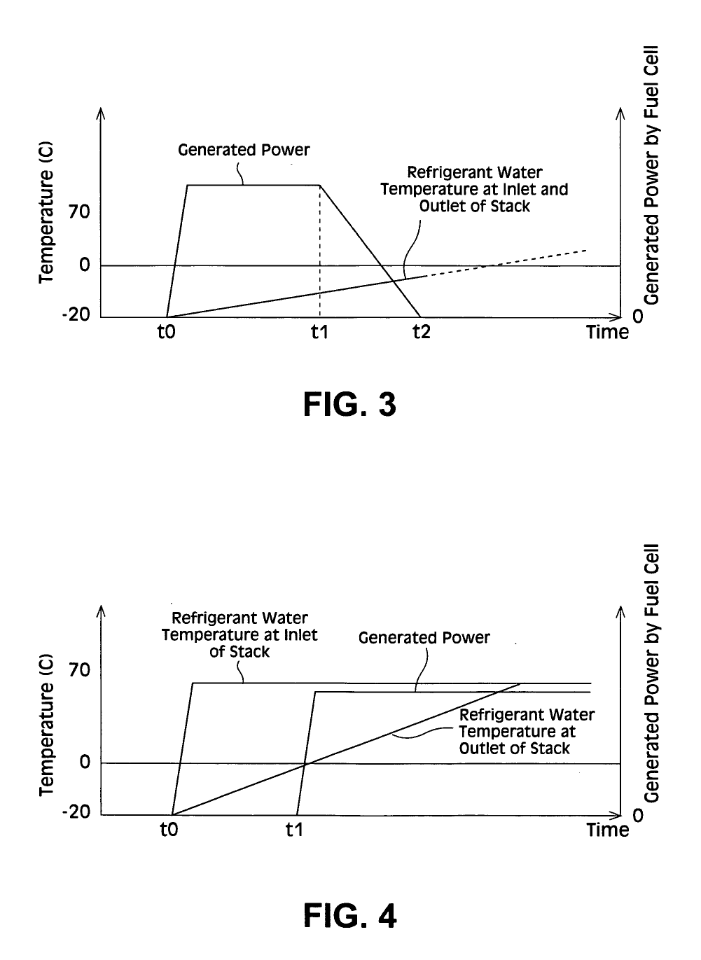

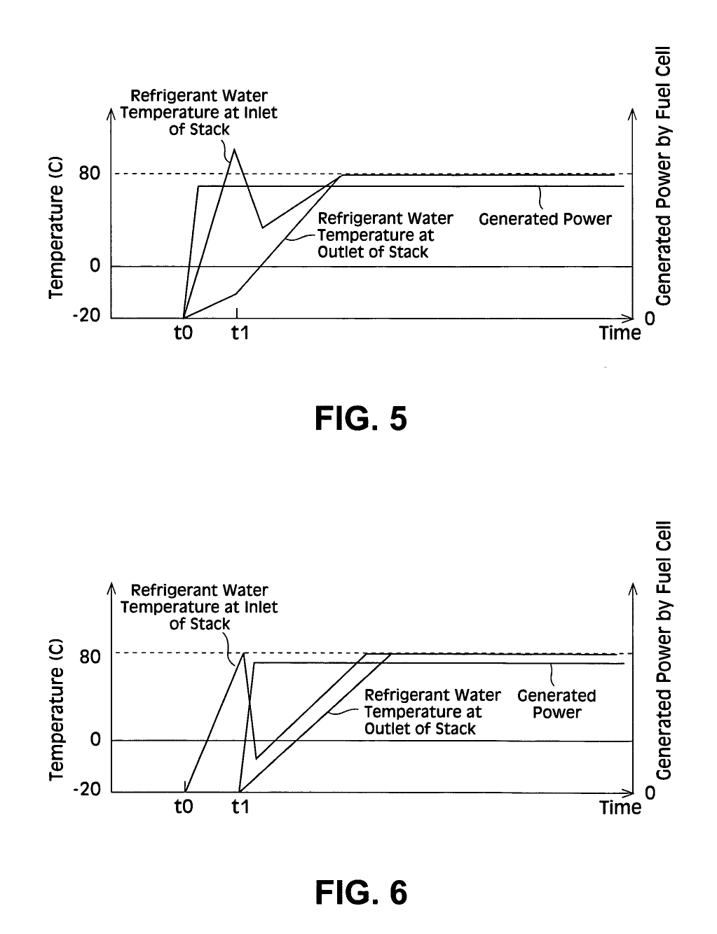

For purposes of comparison, FIGS. 3-4 are graphs that illustrate temperature and generated power relative to elapsed time in related fuel cell systems. In contrast, FIGS. 5-6 illustrate exemplary temperature and generated power relative to elapsed time for embodiments of fuel cell system conforming to the principles of the invention described herein.

FIG. 3 is a graph of a related fuel cell system. In particular, FIG. 3 shows relations among time, temperature and electric power in a related fuel cell system that does not have any heating unit to heat the refrigerant. As illustrated in FIG. 3, without heating units, a period of time is required to warm the refrigerant after starting electricity generation. However, after the fuel cell starts and electricity generation commences, water forms and freezes in the fuel cell stack, which prevents or reduces the fuel gas supply and decreases electricity generation efficiency.

Without heating units, it takes time to warm up the refrigerant after starting the generation of electricity. Some time after starting electricity generation, formed water may freeze in the stack. This may block the gas supply for the reaction or decrease the electricity generation efficiency, decreasing or eliminating the possibility of producing electric power.

FIG. 4 shows relations among time, temperature and electric power in a related fuel cell system which has heating units to heat the refrigerant in a reservoir. When the heat reservoir is used as a heating unit, the temperature at the inlet of the stack becomes the temperature of the warmed refrigerant after starting the system. However, a period of time is required for the temperature at the outlet to reach a temperature above 0 degrees Celsius, which again prevents or reduces the operating efficiency for the fuel cell system to produce electricity. Therefore, the heating units may require a large secondary power source or heat reservoir to heat the refrigerant until sufficient electricity generation is achieved.

When the heat reservoir is used as a heating unit, the temperature of the refrigerant at the inlet of the stack may equal the temperature of otherwise warmed-up refrigerant normally present after running the system. However, it takes time for the temperature of the refrigerant at outlet to reach above 0 degrees Celsius, which prevents electricity generation until the refrigerant is above that temperature threshold. Therefore, the system requires a large secondary power source or heat reservoir to be used in heating the refrigerant until electricity generation is started.

FIG. 5 shows a graph of relations among time, temperature and electric power of the exemplary fuel cell system 1 of FIG. 1 that heats refrigerant within a bypass of the fuel cell stack. At the start, the refrigerant temperature at inlet of the fuel cell stack can be increased to the predetermined temperature in shorter time with less heat capacity since the exemplary fuel cell system only increases temperature of the refrigerant within the passage bypassing fuel cell stack 2 and radiator 10. Temperature at the outlet of fuel cell stack 2 is also warmed by electricity generation of the stack. When three-way valve 7 is switched to introduce refrigerant into the fuel cell stack 2, temperature in the stack is increased, as well as the temperature at the outlet. Since the internal temperature of fuel cell stack 2 is increased, formed water does not freeze as the electricity generation continues.

FIG. 6 is a graph that illustrates temperature and electric power over time for the second exemplary embodiment of fuel cell system 1 shown in FIG. 2. In FIG. 6, the pump moves and heats the refrigerant before electricity generation is started, where a secondary power source operates the pump. First, the refrigerant temperature at inlet of the fuel cell stack can be increased to the predetermined temperature in shorter time with less heat capacity since the system only increases temperature of the refrigerant within the passage bypassing fuel cell stack 2 and radiator 10. As soon as the refrigerant temperature reaches the predetermined temperature, three-way valve 7 is switched to the fuel cell stack 2 side to start electricity generation by fuel cell stack 2. At the same time, the power source of pump 5 is switched from secondary power source to the one of fuel cell stack 2. Depending on the size of heat capacity of the fuel cell stack, refrigerant temperature may drop at the outlet of the stack. Elapsed time for the temperature to reach above 0 degrees Celsius may be shortened by heat from pump 5 and fuel cell stack 2 so that it is possible to increase the temperature at the outlet of the stack before the formed water freezes in the stack.

Various embodiments of the invention have been described. These and other embodiments are within the scope of the following claims.

1. A fuel cell system comprising:
a fuel cell stack;
a main circulation passage where a refrigerant flow through the fuel cell stack;
a bypass passage where the refrigerant bypasses the fuel cell stack;
a valve that switches the refrigerant between the main circulation passage and the bypass passage;
a heating unit that heats the refrigerant;
a sensor that detects a temperature of the refrigerant; and
a controller that controls the valve to direct the refrigerant flow through the bypass passage, wherein the controller engages the heating unit to heat the refrigerant that bypasses the fuel cell when the temperature of the refrigerant is below a first predetermined value, and when starting the fuel cell system.

2. The fuel cell system of claim 1, wherein the controller switches the valve to direct the refrigerant through the fuel cell stack when the temperature of the refrigerant is above a second predetermined value greater than the first predetermined value.

3. The fuel cell system of claim 2, wherein the fuel cell stack starts electricity generation when the valve switches the refrigerant to the main circulation passage and when starting the fuel cell system.

4. The fuel cell system of claim 2, wherein the fuel cell stack starts electricity generation when the valve switches the refrigerant to the bypass passage and when starting the fuel cell system.

5. The fuel cell system of claim 1, wherein the sensor is an outside air temperature sensor which detects outside air temperature, and wherein the controller calculates a time for switching the valve to direct the refrigerant through the main circulation passage based on the outside air temperature and a heat capacity of the heating unit.

6. The fuel cell system of claim 1, further comprising a pump that creates a circulation of the refrigerant, wherein the controller drives the pump when the temperature of the refrigerant is below the first predetermined value and when starting the fuel cell system.

7. The fuel cell system of claim 1, further comprising an actuator which actuates the pump, wherein the pump is the heating unit, the refrigerant discharged from the pump cools the actuator, and the pump is driven with a high load to heat the refrigerant.

8. The fuel cell system of claim 1, further comprising a secondary power source that supplies power to the heating unit.

9. The fuel cell system of claim 1, wherein the bypass passage bypasses a radiator during fuel cell system startup.

10. A fuel cell system comprising:
a fuel cell stack;
a main circulation passage where a refrigerant flows through the fuel cell stack;
a pump that creates a circulation of the refrigerant;
a bypass passage where the refrigerant bypasses the fuel cell stack;
a valve which automatically switches a flow of the refrigerant between the bypass passage and the main circulation passage, wherein the valve directs the refrigerant through the bypass passage when the temperature of the refrigerant is below a first predetermined value, and wherein the valve directs the refrigerant through the main circulation passage when the temperature of the refrigerant is above a second predetermined value greater than the first predetermined value;
a heating unit that heats the refrigerant;
a sensor that detects a temperature of the refrigerant; and
a controller that engages the heating unit to heat the refrigerant and drives the pump when the temperature of the refrigerant is below a first predetermined value and when starting the fuel cell system.

11. A method for starting a fuel cell system comprising:
detecting a temperature of a refrigerant in a fuel cell stack when the temperature of the refrigerant is below a first predetermined value;
directing the refrigerant from a main circulation passage through the fuel cell stack to a bypass passage to bypass the refrigerant away from the fuel cell stack; and
heating the refrigerant that bypasses the fuel cell stack, wherein heating the refrigerant comprises heating the refrigerant with a heater located within the bypass passage.

12. The method of claim 1 1, further comprising directing the refrigerant flow through the main circulation passage when the temperature of the refrigerant is above a second predetermined value greater than the first predetermined value.

13. The method of claim 12, further comprising starting electricity generation with the fuel cell stack when the refrigerant is directed through the main circulation passage and when starting the fuel cell system.

14. The method of claim 12, further comprising starting electricity generation with the fuel cell stack when the refrigerant is directed through the bypass passage when starting the fuel cell system.

15. The method of claim 1 1, further comprising:
detecting outside air temperature with a sensor; and
calculating a time for directing the refrigerant through the bypass passage based on the detected outside air temperature and a heat capacity of a heating unit.

16. The method of claim 1 1, further comprising circulating the refrigerant with a pump that heats the refrigerant.

17. The method of claim 16, further comprising cooling an actuator that actuates the pump with the refrigerant discharged from the pump.

18. The method of claim 11, further comprising providing power from a secondary power source when heating the refrigerant.

19. The method of claim 11, further comprising directing the refrigerant through a second bypass passage away from a radiator during fuel cell system startup.

20. A fuel cell system comprising:
means for detecting a temperature of a refrigerant in a fuel cell stack;
means for bypassing the refrigerant away from the fuel cell stack;
means for directing the refrigerant from a passage through the fuel cell stack to a bypassing means to bypass the refrigerant away from the fuel cell stack when the temperature of the refrigerant is below a first predetermined value; and
means for heating the refrigerant that bypasses the fuel cell stack.

21. The system of claim 20, further comprising means for directing the refrigerant flow through the passage through the fuel cell stack when the temperature of the refrigerant is above a second predetermined value greater than the first predetermined value.

22. The system of claim 20, further comprising:
means for detecting outside air temperature; and
means for directing the refrigerant through the bypassing means for a period of time based on the detected outside air temperature and a heat capacity of the heating means.

23. The system of claim 20, further comprising means for directing the refrigerant through a second bypassing means away from a radiator during fuel cell system startup.
